(19) United States
(12) Patent Application Publication
(10) Pub. No.: US 2017/0213264 A1
(43) Pub. Date: Jul. 27, 2017

(54) SYSTEMS, METHODS AND ARCHITECTURE FOR SENDING MESSAGES AND GIFTS DELAYED IN TIME

(71) Applicant: John J. Donovan, Hamilton, MA (US)

(72) Inventor: John J. Donovan, Hamilton, MA (US)

(21) Appl. No.: 15/412,917

(22) Filed: Jan. 23, 2017

Related U.S. Application Data
(60) Provisional application No. 62/287,610, filed on Jan. 27, 2016.

(51) Int. Cl. G06Q 30/06

(52) U.S. Cl. CPC G06Q 30/0601

(57) ABSTRACT

eGifting architecture enables user to send a variety of gifts in the present or the future. The architecture ensures that the best gifting solution for both the sender and recipient are given. The sender is also provided an array of solutions for sending a gift.

### CROSS-REFERENCE TO RELATED APPLICATIONS

This application claims priority to U.S. Provisional patent application Ser. No. 62/287,610, filed Jan. 27, 2016, the contents of which are herein incorporated by reference in their entirety.

### FIELD OF THE INVENTION

The present invention relates to delayed transmission of messages and gifts.

### BACKGROUND

Global e-commerce sales were set to grow 25% in 2015 according to InternetRetailer (https://www.internetretailer.com/2015/07/29/global-e-commerce-set-grow-25-2015). eMarketer projects e-commerce sales will eclipse $3.5 trillion by 2019. Consumers worldwide were projected to spend $1.672 trillion online in 2015—7.3% of overall global retail sales ($22.822 trillion this year). Most of the growth in the e-commerce sector will come from mobile purchases, mainly in rural areas. (https://www.internetretailer.com/2015/07/29/global-e-commerce-set-grow-25-2015) Other factors that have been driving the rampant e-commerce growth is an increase in the US consumer's willingness, frequency and ability to spend online. (https://www.internetretailer.com/2015/07/29/global-e-commerce-set-grow-25-2015)

The Top 10 e-commerce countries based on projected 2015 web sales along with their year-over-year growth:
China: $672.01 billion (42.1%)
U.S.: $349.06 billion (14.2%)
U.K.: $99.39 billion (14.5%)
Japan: $89.55 billion (14.0%)
Germany: $61.84 billion (12.0%)
France: $42.60 billion (11.1%)
South Korea: $38.86 billion (11.0%)
Canada: $26.83 billion

In 2015, the total sales of Cyber Monday added up to $2.3 billion, which was a 29% increase from the previous year. But, on Nov. 11, 2015—China's big buyer day—Alibaba only took two hours to reach $2 billion in sales on Singles Day and their sales surpassed $9 billion by the end of the day. (https://www.shipwire.com/w/blog/9-e-commerce-trends-2015-influence-buyer-experience/)

MyCustomer.com examined the growth of social gifting and effects on e-commerce. Social gifting is a trend that has been targeted by a number of start ups including Socialgift, SendItLater and Wrapp. Even Facebook has decided to move into the ecommerce field through the acquisition of Karma, “a startup that enables gifting, but also lets the recipient personalize their gift, swap it for another or donate it to charity.” According to Ann Longley, head of social strategy at MEC, social gifting is expected to build with the millennial generation.

Along with social gifting, egifting has also become more prevalent among millennials. (https://blackhawknetwork.com/research-finds-egift-growth-outside-of-gifting-occasions/)

According to the study, millennials purchase more egifts than any other age group (76%) along with receiving more egifts (71%) (https://www.internetretailer.com/2011/01/11/38-online-consumers-say-they-spent-more-holiday) 38% of consumers who bought holiday gifts say they spent more money this year than previously according to a study conducted by InternetRetailer. Along with these findings, they found that 29% of respondents were more comfortable with online shopping this year than compared to previous years. 25% of the respondents found that retailers emailed them more offers they liked.

According to Chris Urinyi, US CEO of Lightspeed Research, there are several key cultural shifts including the benefits of speed, convenience and price that are influencing e-retail growth. (https://www.internetretailer.com/2011/01/11/38-online-consumers-say-they-spent-more-holiday) Mainly, people are realizing the fact that they are “able to not only find products online, but also derive reviews and price comparisons at a moment's notice.”

According to ATKearney, “across the world shoppers are buying more products online—and in particular, on their mobile phones—so there is clearly an opportunity.” This is the opportunity we are trying to enhance through the aspects of this patent for delayed gifting. See FIG. 1 for total ecommerce market size in billions (usd) and FIG. 2 for the gifting market size in billions (USD). See U.S. Pat. No. 7,197,475, US20090132387, WO2011103664, US20130211970, and US20130268432, the contents of each of which are incorporated herein by reference.

### SUMMARY

Sending gifts, messages, money, and gift cards into the future can make any day or special occasion better; however, all of these items' inventory, price, and availability fluctuates. Additionally, giving any or all of these items to someone doesn't guarantee a gift which will be liked by the recipient.

This gifting architecture enables user to send a variety of gifts in the present or the future. The architecture ensures that the best gifting solution for both the sender and recipient are given. The sender is also given an array of solution for sending a gift. For example, the sender can select one, or any combination of selecting a gift from the following:
1. Picking a specific gift
2. Picking gift by characteristics (e.g. price point, color, size, type)
3. Picking gift by attributes (Either sender, recipient, or both, e.g. age, likes, sex)
4. Picking gift using heuristic algorithms on which a machine learns from past experiences and suggests the “perfect gift” (e.g. sender is an avid red sox fan and has sent red sox paraphernalia many times in the past, recipient receives a suggested red sox baseball cap)

These four ways of selecting a gift can be used together, by themselves. or in any combination.

In certain aspects, the invention may include systems and methods for a user to specify a set of gifts to be sent into the future to a recipient that are independent of the inventory and price fluctuations. Systems and methods of the invention may allow a user to select a specific set of gifts or a specific gift, from an array of currently available gifts. Systems and methods of the invention may allow a user to select from an array of currently available gifts from within selected characteristics of gifts. Systems and methods of the invention may allow a user to select from an array of currently available gifts from within some or all sender attributes. Systems and methods of the invention may allow a user to select from an array of currently available gifts from within some or all recipient attributes.

In certain aspects, the invention may include systems and allowing for a corrective gifting engine to allow a gift recipient to receive gifts available at that present instance from an array specifically corrected, customized, and tailored for them. Systems and methods of the invention may allow for a Heuristic engine which learns from past gifting, past gift characteristics, and past attributes for a specific sender and receiver. Later the engine suggests or selects best gifts for an individual at that present instance. Systems and methods of the invention may allow for sender to receive recommendations on gifts to send to unique recipient based on characteristics of gift. Systems and methods of the invention may allow for sender to receive recommendations on gifts to send to unique recipient based on dynamic sender attributes. Systems and methods of the invention may allow for sender to receive recommendations on gifts to send to unique recipient based on dynamic recipient attributes. Systems and methods of the invention may allow for recipient to receive recommendations on gifts to select based on characteristics of gift. Systems and methods of the invention may allow for recipient to receive recommendations on gifts to select based on dynamic sender attributes. Systems and methods of the invention may allow for recipient to receive recommendations on gifts to select based on dynamic recipient attributes. Systems and methods of the invention may allow for sender to receive recommendations on gifts to send to unique recipient based on external sources of data, including but not limited to gifting and consumer habit data, weather trends after detecting and predicting trends. Systems and methods of the invention may allow for the Heuristic Gifting Machine to select gifts for the sender/recipient based on Meta Data, for example, the meta data would weight the validity of the external data or the information about the sender/recipient.

### BRIEF DESCRIPTION OF THE DRAWINGS

FIG. 1 shows total ecommerce market size in billions (usd).

FIG. 2 shows gifting market size in billions.

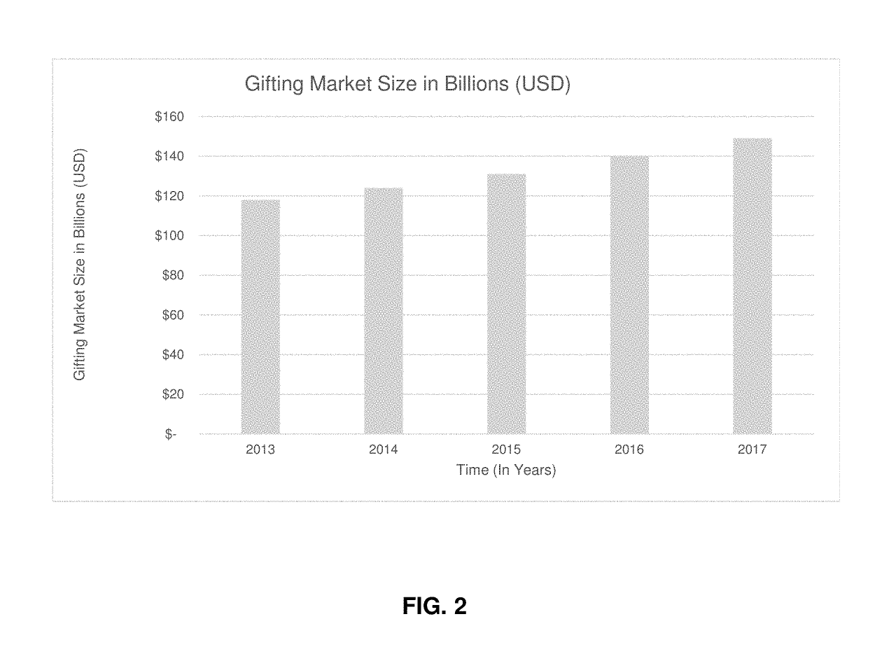

FIG. 3 diagrams an exemplary process of the invention.

FIG. 4 shows specific gift selection according to certain embodiments.

FIG. 5 shows characteristic based gift selection according to certain embodiments.

FIG. 6 shows attribute based gift selection according to certain embodiments.

FIG. 7 shows heuristic based gift selection according to certain embodiments.

FIG. 8 illustrates an example of eGifting architecture according to certain embodiments.

### DETAILED DESCRIPTION

Examples use cases:

1. Service men, business people or volunteers that must be traveling or out of communication for a period of time. When special events occur for important people in their lives like anniversaries, birthdays, they will be unable to be present. For example, a sailor who must go on a submarine for a tour on duty for 75 days with no communication will not be there for a loved one's birthday, Valentine's Day, Christmas etc.

2. A forgetful husband who can't keep track of birthdays and anniversaries and would want a mechanism to in one sitting schedule messages and gifts.

3. A terminally ill person who wishes to have some presence at their child's birthdays or other special events in the future.

If a person chooses a particular gift on an ecommerce site, pays for it (at time T) and chooses to send that gift into the future, (T +A) at that time the gift might not be available or the price of the gift is changed or the model has changed. This patent presents a solution.

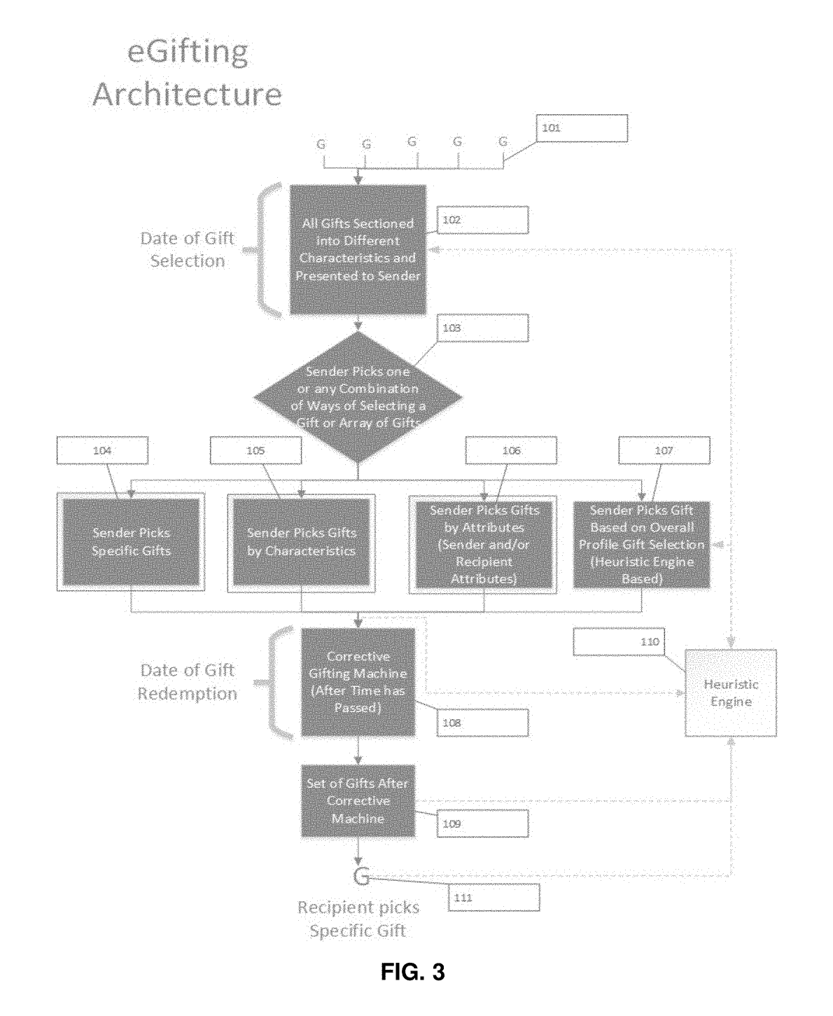

FIG. 3 illustrates how these work together or separately to come up with an output set of gifts for the recipient.

This process is depicted in FIG. 3. Where: Box 101 depicts the universe of gifts; Box 102 depicts the function of the machine that attaches characteristics to each gift; Box 103 Depicts the process that the sender uses to determine how they wish to present the gifts to the recipient; Box 104 depicts how the sender can decide to send a specific gift; Box 105 depicts how the sender can decide to send a gift based on characteristics; Box 106 depicts how the sender can decide to send a gift based on attributes of the sender, recipient, or both; Box 107 depicts how the sender can decide to send a gift based chosen by the heuristic engine which bases the gifts from past information collected regarding user data; and Box 108 depicts that it must be realized that in the future, some of those gifts are not available.

There needs to be a corrective method to update the set of gifts available to recipient. Box 109 depicts the set of “best gifts” are presented to the recipient to choose from, Box 110 depicts how the heuristic engine collects and analyzes data from the whole process to create later create more specific suggestions, and Box 111 depicts the gift the recipient chose from the array presented to them

Overall Gifting Architecture

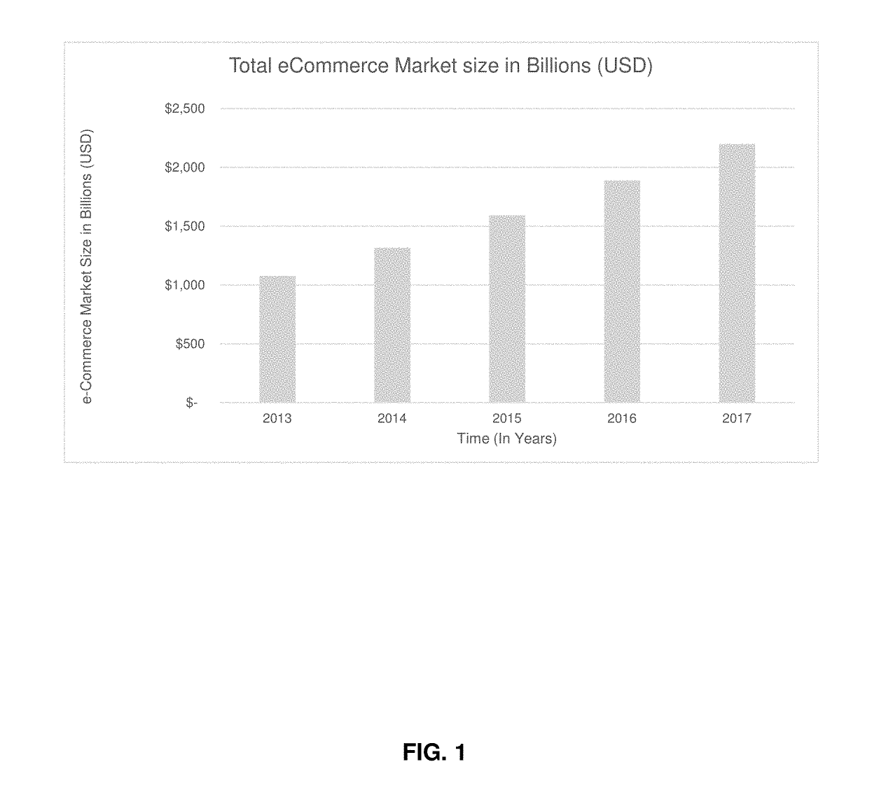

To create a way for users of an E-commerce site to be able to receive any possible type of gift, gift card, or money independent of inventory and price fluctuations, FIG. 1. This invention allows for a sender to send a gift, or set of gifts into the future. Based on the constraint, and the importance the sender gives to these constraints, the recipient receives a set of gifts. This set of gifts is independent of inventory and price fluctuation but includes exactly the same, or similar characteristics that the sender wanted. The recipient then selects a specific gift from the given set.

Gift Selection Engine

A selection engine allows for the recipient to receive an array of gifts based on which gifts the sender had selected, using one or a combination of the following methods (FIG. 3-103); the specific gift (FIG. 3-104), the characteristics the sender wanted for a gift (FIG. 1-105), the attributes of either or both the sender and recipient (FIG. 3-106), and from past information, heuristic learning machine (FIG. 3-107). This allows for the gifts to be customized for the recipient and have them match the attributes (style) of the sender.

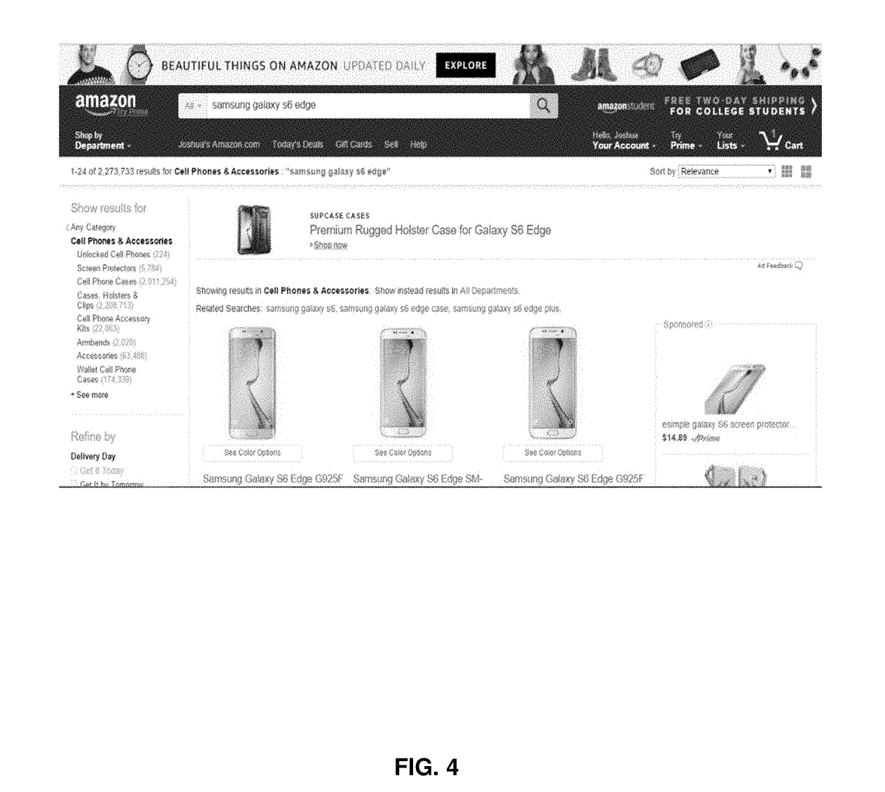

FIG. 4 shows how a user can select also a specific gift to send over to a recipient. This specific gift can be chosen to be sent on the later date. An importance weight will be attached to these products. This weighting will be considered when creating a corrected output set of gifts for the recipient.

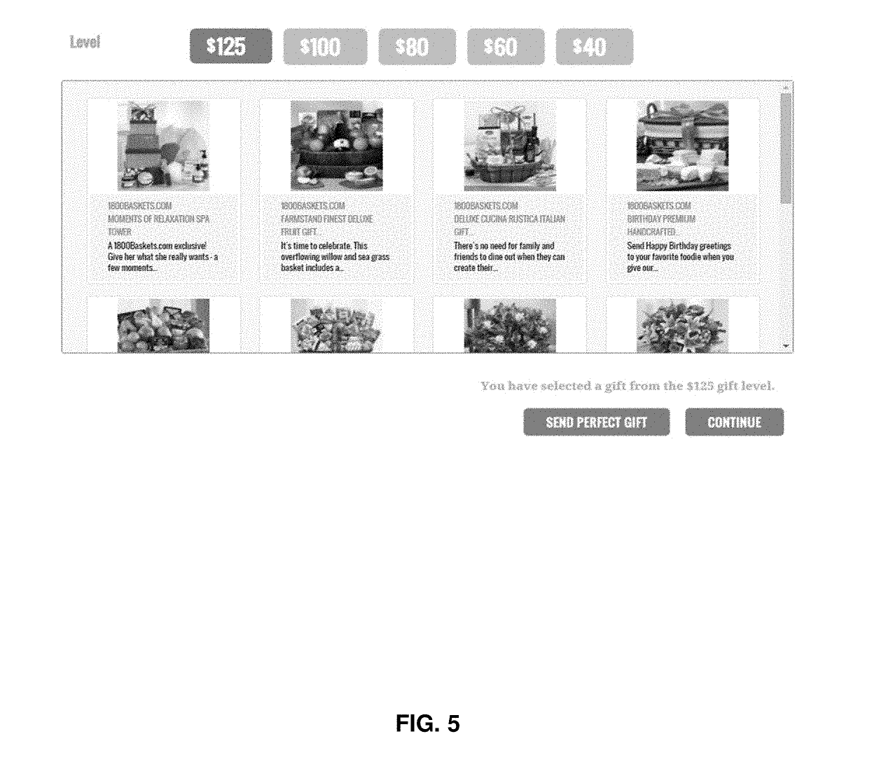

FIG. 5 shows an example of how characteristic based gifting can occur. On the example above, the characteristic used is price. The sender can select to send gifts solely by the price characteristic. The recipient will get gifts only within this characteristic ($125 dollars).

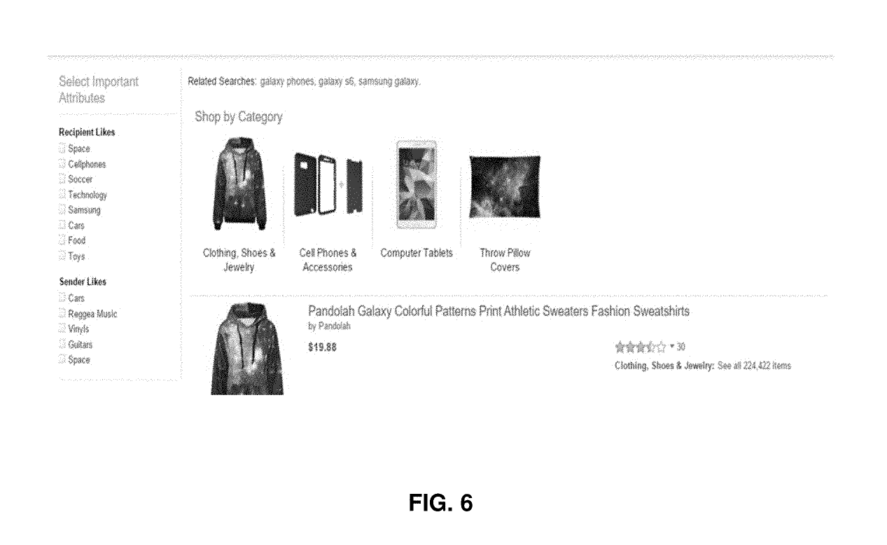

FIG. 6 is an example of how attribute based gifting could work. In this example the sender can select different “likes” both or either themselves of the recipient have. The system would automatically refresh the gifts available as different likes are chosen. This serves as just a simple example of how attribute based gift selection could work. The system can drastically be expanded but the main idea is that attributes (likes in the example FIG. 6) can be chosen, an importance weighting can be attached, and later, the recipient will get a set of gifts based on these things.

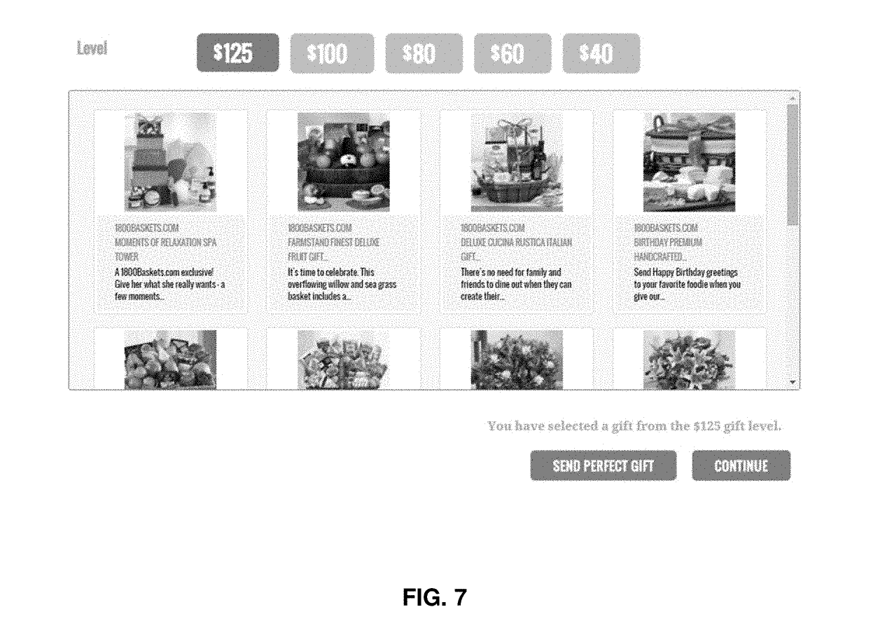

FIG. 7 shows a button expressing “Send Perfect Gift.” This button uses the heuristic engine to create a set of gifts that are based on past events, attributes, characteristics, and other information. These set of gifts are presented to the recipient on date the sender selected.

Corrective Gifting Machine

The Corrective Gifting Machine is responsible for taking in all of the outputs from the Gift Selection Engine and re-analyzing them regarding to some aspects of the gift giving process (FIG. 3-108). Some examples include (but are not limited to) the amount of time passed, which gifts are available, and past attributes for a specific sender and receiver. All this information is weighted for the effect they have on user preferences, along with external factors including news reports about particular gifts and then the machine takes all of this into account to suggest/select the best gifts for an individual at that present instance.

Heuristic Gifting Engine

A key in gifting is gifting into the future, but a change in time means that there might be a change in characteristics a gift might possess, as well as a change in society and change in attributes for sender and receiver (FIG. 3-110). Our heuristic gifting engine invention learns from past gift characteristics specified from the sender, as well as attributes for sender and receiver and the change they might have. The engine stores and analyzes data from each gift sent and as more gifts are sent, starts learning what the sender's “style” of gifting is for each of the people to whom they send a gift. The engine also learns from the selection habits of the recipient. This means that the engine analyzes which gift characteristics the recipient usually selects from within the set of gifts given over time. Furthermore, the machine detects the changes in attributes the sender and receiver have. As the attributes (for example, age, likes, location) of each the sender and receiver change, the engine takes and weights these changes to suggest the best possible gift characteristics to the sender when a new gift is sent. The engine also takes into account external factors including but not limited to news articles, consumer trends reports, technological innovation, changes in societal impressions of new products and etc.

The following represents the gifts that are available today at a particular price, that a particular person wishes to send.

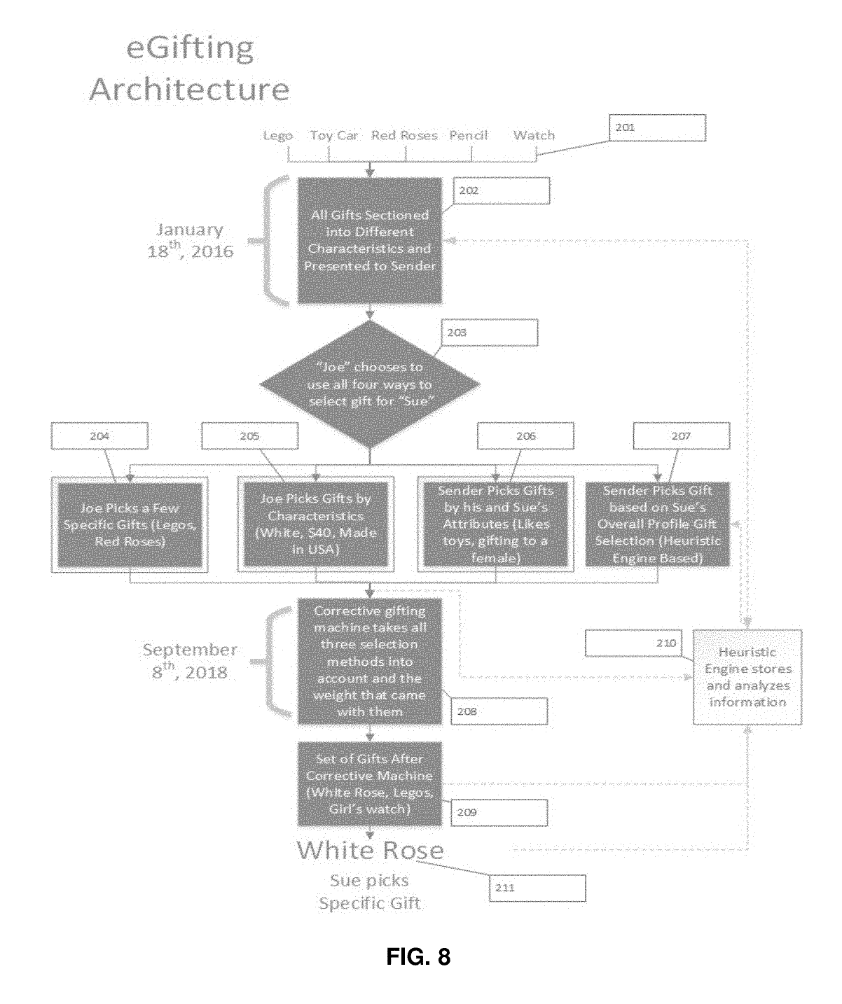

FIG. 8 illustrates how the overall system would work in a specific instance. In this instance, a sender, “Joe”, is sending a gift two years into the future to his daughter, “Sue.”

Step 1—Machine's Characterization of Gifts (FIG. 8-202)

The machine auto updates, at all times, the gifts available at that date and time and divides them into different characteristics in order to later be able to present the gifts in this way to the sender of the gift if they so choose to have this feature. During this step the heuristic engine also is fed with information on which gifts are available at that time and their characteristics.

Step 2—User, “Joe”, Selects Array of Gifts (FIG. 8-203)

Joe selects a way of picking the array of gifts that will be made available to Sue in the future. Joe selects to use all four different ways of selecting the array of gifts. This includes picking a few specific gifts, choosing a few gift categories, and picking gifts based on his attributes as well as Sue's attributes. During this step Joe also selects the importance of the way the gift is selected.

Step 2a—Specific Gifts (FIG. 8-204)

Joes selects a few specific gifts to make sure those are in the array of gifts made available at the time that Sue redeems her gift. He chooses Legos and Red Roses. The machine will try to incorporate these into the final array when Sue gets them since Joe marked these as very important to have in that final array.

Step 2b—Gifts Based on Characterization (FIG. 8-205)

Joe selects to pick a few characteristics that he wants the gifts available to Sue to have. These include gifts that are white, $40, and made in the USA. He specifies that white gifts are very important to him.

Step 2c—Gifts Based on Sender and Recipient Attributes (FIG. 8-206)

Joe also selects to use both his attributes and Sue's attributes into selecting the final array. These are not as important for Joe but he still wants the engine to consider them when making the final array of gifts.

Step 2d—Overall Profile Based Gifting (FIG. 8-207)

Joe also selects to use both the overall profile made for Sue. This profile takes a great array of information in it. Some examples include, but are not limited to: all of her past and present attributes, gift selection, social media, external factors, and latest consumer trends. The Heuristic engine then, considering all of this historical information, creates an array gifts for Sue.

Step 3—Corrective Engine (FIG. 8-208)

As time passes, the specific gifts that Joe chose might not be available. The machine looks at present availability of gifts and uses the importance given to the specific gifts, characteristics, attributes, current marketing information, and more, to create a final array of gifts. This array is curated, corrected, and then is presented to Sue.

Step 4—Gift Selection (FIG. 8-209)

Sue gets the final array of gifts that has been corrected and curated. She then selects the gift she wants from the ones presented to her.

Step 5—Heuristic Engine (FIG. 8-210)

After Sue selects her gift, the Heuristic engine gathers information regarding her choice and her actions that made her come to that conclusion. Then, the engine will analyze the information and will use it to suggest gifts when someone is gifting to Sue or when she is gifting to someone.

Gift Selection Engine

The gift selection engine gives the sender a chance to select a gift or array of gifts to be sent to the recipient. The different arrays of gifts selected are either handpicked by the user or curated by the gift selection engine.

Characterization of Gifts

Equation 1 - Gift Characterization

$${G}_{t} = {⋃}_{i = 1 to m} {C}_{j , t}$$

Where:

G stands for Gifts

C stands for characteristics of the gift

i is an index of characteristics of the gift

t stands for time

An instance of this equation is:
Flowers at 12 noon, 10/25/2015=$40, 51bs, daffodils, Long Island, NY . . .

A gift (G) consists of a set of characteristics (C).

Examples of possible C′s:
Price
Type
Desirability by Sender
Desirability by Recipient
Weight
Size
Physical Characteristics
Availability in Location
Brand
Seasonality
Country of Origin

User Interface

The User Interface for this Machine is what allows the Sender to choose some or all the various methods of gift selection and curation, including specific gift selection, characteristic based gifting and/or attribute based gifting. This user interface takes all of the selections the sender makes and feeds this to the back-end gift selection engine which is responsible for the curation and gift selection for recipients. All of the sender selections here are also fed into the Corrective Gifting Machine and the Heuristic Gifting Engine.

Specific Gift Selection

Specific Gift Selection is a method of gifting that allows the sender to choose a specific gift that they want to send to the recipient. The Gift Selection Engine will take note of the gift, and its various characteristics, including but not limited to size, color, price, etc. When it comes time for the gift to be sent out, the Gift Selection Engine chooses the identical gift and sends it to the recipient. This is important because it gives users the ability to hand pick a gift to send. This helps in sending the best gift possible.

The sender(m) will pick a set of specific gifts S at time t.

Equation 2—Specific Gift Selection

$${S}_{t , m} = {⋃}_{j = 1 to m} {H}_{j}$$

Where:

S stands for the set of chosen gifts

H stands for the individual gifts. Each one which is a G.

j is the index associated with the gift

An instance of this:
Set of chosen gifts at 12 noon, Oct. 25, 2015=Flowers, Baseball Bat, Toy Car

When the time comes to deliver the gift, the recipient gets a set of gifts based on the specifications of the sender. The basic idea behind our equation: the higher the j is, the more flexibility the recipient has of receiving a gift that the sender wanted them to receive.

Equation 3—Recipient Receives

$${R}_{t + Δ , m} = {⋃}_{j = 1 to m} {H}_{j}$$

Where:

R stands for the set of gifts the recipient receives

H stands for the individual gifts. Each one which is a G.

j is the index associated with the gift

An instance of this:
Set of Gifts Presented to the recipient at 9am, Jan. 24, 2017=Flowers at t+Δ, Baseball Bat at t+Δ, Toy Car at t+Δ

If Δ goes to 0, then only a few of the characteristics i create a problem for those gifts. As Δ increases, the complexity for fulfilling the sender's specific gifts becomes more challenging.

If the sender has picked a small number of gifts (for example, j=1) then the complexity of assuring that this specific gift is given to the recipient becomes even more challenging. The corrective engine will take the set of gifts at t and at t+Δ and present to the user set of gifts that is most appropriate and described later.

Characteristic Based Gifting

Characteristic Based Gifting (e.g. price, type, color, size, etc . . . ) is a method of gifting that allows the sender to choose and rank certain characteristics the intended gift should have. The sender, when choosing the types of gifts, they want to send, will have the option to input various characteristics, for example Red, and then give the importance of this characteristic a weighting, for example 3. The machine will take all characteristics and weight respective weightings into account before presenting an output of possible gifts to select from. The importance of this function of the Gift Selection Engine is that it allows another method of gift selection which is tailored to the specific requirements from the sender. This also helps in sending the best gift possible.

Equation 4—Characteristic Based Gifting

$${S}_{t , m} = {⋃}_{j = 1 to m} {M}_{j} ⋃ {C}_{n , w}$$

Where:

S stands for the set of chosen gifts

M stands for the individual gifts with certain characteristics Cₙ. Each M is a G.

j is the index associated with the gift

n is the index associated with the characteristic

w stands for the weighting assigned to each C

An instance of this:
Characteristic based gifting:
Senders Gifts on Jan. 24, 2017=[Flowers (W=8)], [Jewelry 22 (W=5)], [1800flowers.com (W=8))], [Red W=3], [etc . . . ]

Equation 5—Corrective Gifting Machine Recipient

$${R}_{t + Δ , m} = f ( Corrective Gifting {Machine}^{′} s Output ) ( {⋃}_{j = 1 to m} {M}_{j} ⋃ {C}_{n , w} )$$

Where:

R stands for the set of chosen gifts

M stands for the individual gifts with certain characteristics Cₙ. Each M is a G.

j is the index associated with the gift

n is the index associated with the characteristic

w stands for the weighting assigned to each C

An instance of this:
Recipient Gifts on Sep. 13, 2018=[Jewelry], [1800flowers.com], [Red Flowers], [etc . . . ]

The corrective gifting machine will take the set of gifts at t and at t+Δ and present to the user set of gifts that is most appropriate and described later.

Attribute Based Gifting

Our goal is to maximize the contentment of the recipient within the constraints of the attributes (sender and recipient e.g. age, likes, sex, etc...) of the gift set by the sender. Therefore, this assures that the set of gifts the recipient gets has the highest weighted attributes of the gift that the sender sent.

Equation 6—Attribute Weighting.

These are obtained by interacting with the sender. In FIG. 1 (103) to determine what the sender feels are the most important attributes about the recipient and themselves.

$${A}_{t , b} = {⋃}_{j = 1 to b} ( {AS}_{t , b , ws} ) + ( {AR}_{t , b , wr} )$$

Where:

A stands for set of gifts with the weighting added

AS stands for attributes of the sender

AR stands for attributes of the recipient

j is the index associated with the attribute

ws stands for the weight on each attribute of the sender

wr stands for the weight on each attribute of the recipient

B stands for each attribute

Weight, W, is on scale from 1 to 10 on importance. For example, the attribute of someone's age is ranked highly since this is a great factor on the set of gifts that can be of interest to this individual.

Attributes of the recipient or sender can include:
Sex
Age
Nationality
Location
Likes
Shopping Behavior

An instance of this:
On Jan. 21, 2017, Soccer Video Game, Pop Music Album, Giftcard to Any Sports Game in the Boston Area=(Sender Attributes Importance on Jan. 21, 2017=Sex [female on Jan. 21, 2017 (W=3)], Age [25 Jan. 21, 2017 (W=7)]+Nationality [Indian Jan. 21, 2017 (W=7))], Location [Boston, Mass. Jan. 21, 2017 (W=4)], Likes [Video Gaines, Baseball, Metal Music, etc . . . Jan. 21, 2017 (W=8))], Shopping Behavior [Shops for music albums eight times a month, shops for video games jerseys two times a month, etc . . . Jan. 21, 2017 (W=9)], etc . . . )+(Recipient Attributes Importance on Jan. 21, 2017=Sex [male on Jan. 21, 2017 (W=8)], Age [22 Jan. 21, 2017 (W=5)] +Nationality [American Jan. 21, 2017 (W=8))], Location [Boston, Mass. Jan. 21, 2017 (W=4)], Likes [Technology, Soccer, Pop Music, etc . . . Jan. 21, 2017 (W=8))], Shopping Behavior [Shops for music albums three times a month, shops for soccer jerseys two times a month, etc . . . Jan. 21, 2017 (W=6)], etc . . . )

The corrective gifting machine will take the set of gifts at t and at t+Δ and present to the user set of gifts that is most appropriate and described later.

Corrective Gifting Machine

This describes the function:
f (Corrective Gifting Machine's Output)

This will be implemented by the machine.

Depending on the weighting the sender sets for specific gift selections, characteristics, attributes, and the length of time passed, the corrective gifting engine will place each gift in one of four baskets of gifts which the recipient will choose the gift from that basket. These baskets allow for the gifts to be “corrected.” This means that the machine creates an output from what is important to the sender and recipient. This output is an array of gifts from which the recipient can choose from. The baskets are as follows:
1. The first basket includes all the gifts that perfectly meet the constraints put forth by the sender.
2. The second basket of is comprised of gifts very similar in characters to the ones specified by the sender.
3. The third of these baskets presents gifts specialized in mitigating deviations in the gift and giving recipient the choice.
4. The fourth basket presents options for gifts that are impossible to fulfill.

From all the gifts available, each gift or alternative gift is put into a specific basket which matches the customization that the sender desires to have. This corrective gifting machine also takes into account the specific attributes of both the sender and recipient. This means that the machine puts gifts into specific baskets based on both the constraints the sender set as well as the attributes of both the sender and recipient.

Equation 7—Recipient Gifts

$$Recipient {g ifts}_{t} = f ( Corrective Gifting Machine ) Basket 1 ⋃ Basket 2 ⋃ Basket 3 ⋃ Basket 4$$

An Instance of This:
1) Sender at Jan. 25, 2016, would like to send a Specific Timex watch on Feb. 25, 2016 to the Recipient
2) Sender selected the specific Timex watch (the price, color, etc . . . ) and nothing else.
3) On at Jan. 25, 2016, the Corrective Gifting Machine, would sort the Timex gift into Basket 1 since it is available and it is the specific gift the Sender wanted to send.
4) Example Instance at Jan. 25, 2016:
   a. Timex Watch=Basketl(Timex Watch) U Basket2(Null) U Basket3(Null) U Basket4(Null)
5) Since there are no other gifts (similar or alternative gifts) selected and since the specific gift if available, this is the gift that is sent to the Recipient for redemption.
6) Since there is only one redeemable gift option, the recipient selects this gift and receives it upon delivery.

Where:

Basket1 at t+Δ=Set of all Gifts on which none of the characteristics of the gift have changed and none of the attributes of the sender or recipient have changed.

Basket2 at t+Δ=The set of all Gifts the sender has chosen where the maximization function of the attributes or characteristics is above a certain threshold for each gift.

Basket3 at t+Δ=All of the Gifts that the sender has chosen, but have been excluded from Basket2 because they were below the threshold. But, with corrective methods, could be given as options to recipient.

Basket4 at t+Δ=All gifts that are impossible to fulfill because of various reasons and no similar gift can be selected based on the attributes of the sender and receiver and characteristics of the gift.

An instance of a Gift being put into Basketl (exact gift):
1. The sender (25-year-old, male) wants to send a gift (one red rose) with characteristic (worth $20) two months into the future
2. As time (t+2 months) passes: the sender is still a 25-year-old, male. The gift is still $20, the flower available is still a red rose
3. Since there are no changes to the attributes or characteristics the gift is put into Basket1
4. Basketl, with this Gift in it, will be presented to the recipient

An instance of a Gift being put into Basket2 (similar gift):
1. The sender (25-year-old, male) wants to send a gift (one red rose) with characteristic (worth $20) two months into the future
2. As time (t+2 months) passes: the sender is still a 25-year-old, male. The gift of a $20 red rose is not available. The flower with the closest characteristics to the original gift (for example a $20 red carnation which is also maximized on the attributes of the sender [he likes spring]) is available
3. Since the $20 red carnation is above the threshold both looking at the attributes of the sender and receiver, and the characteristics of the gift it is put into Basket2
4. Basket2, with this Gift in it, will be presented to the recipient

An instance of a Gift being put into Basket3 (mitigating deviations in the gift and giving recipient the choice):
1. The sender (25-year-old, male) wants to send a gift (one red rose) with characteristic (worth $20) two months into the future
2. As time (t+2 months) passes: the sender is still a 25-year-old, male. The gift of a $20 red rose is not available. The flower with the characteristics to the original gift is, at t+2 months, not available, but will be in t+5 months
3. Since the $20 red rose is below the threshold both looking at the attributes of the sender and receiver, and the characteristics of the gift it is put into Basket3 with a message of the date of closest availability that will bring it above the threshold
4. Basket3, with this gift and message to correct the deviation of attributes of the sender and recipient and characteristics of the gift in it, will be presented to the recipient. That message can be sent either to the sender, who can mitigate it, or the recipient, who can mitigate it.

An instance of a Gift being put into Basket4 (impossible to fulfill gift):
1. The sender (25-year-old, male) wants to send a gift (one red rose) with characteristic (worth $20) two months into the future
2. It is impossible to fulfill this gift because of many reasons. Any substitute of the gift is below the threshold. No mitigation can occur. Some reasons to make gift impossible to fulfill include:
   a. Illegal in some parts
   b. Health quarantine
   c. Natural disaster occurs
   d. Stolen
   e. Gift was lost to higher bidder
   f. Unique gift that was destroyed
3. Since gift is impossible to fulfill it is but into Basket4
4. The sender is notified explaining the reasons the gift cannot be fulfilled and the money for purchase is given back

Heuristic Gifting Engine

The Heuristic Engine can mine all the data including characteristics of the recipient, characteristics of the sender, and characteristics of the gift to do the following:
1. Feedback to the sender on his second selection or other knowledgeable selection of gift
2. More importantly, what nobody else has done, it can give feedback to the recipient as to which gifts within the basket is best to choose
3. It will help in narrowing and more effectively choosing the gifts that will go into baskets two and three in the corrective gifting machine
4. Eventually, with enough experience, the sender would only need to specify who the gift is going too and one or two attributes (such as price), hit return, and the heuristic engine will pick the gift

This Engine takes into account all the possible data we have access to; this includes but is not limited to:

| Data (Examples but not limited too) | Meta-Data (Examples but not limited too) |
|---|---|
| The characteristics that both the sender and | Reliability of the Characteristics for both |
| recipient have based past decisions on | Sender and Recipient |
| The attributes of the sender and recipient | Reliability of the Attributes for both Sender |
| | and Recipient |
| The gift array that the sender has selected if they | Reliability of the Gift Selection History |
| went through that process | |
| The characteristics and their rankings of | Reliability of the Characteristics and |
| importance if the sender went through that | Importance |
| process | |
| The change in news stories regarding gifts | Reliability of News Articles regarding Gifts |
| The change in trends along with society | Reliability of Societal Trends |
| Defective toys | Reliability of Defective Toys News |

An instance of the Heuristic Gifting Engine using Data would be:
1) A sender goes into an e-commerce site on Jan. 15, 2016 and selects that he wants to send a Plastic Toy Car to his child for his birthday on Feb. 1, 2016.
2) As time passes to Feb. 1, 2016; the Heuristic Gifting Engine will be checking for new data about the toy, including external data.
3) The Heuristic Gifting Engine finds external data indicating that there have been recalls with this toy due to lead based paint being dangerous to children.
4) The Heuristic Gifting Engine will take this new information, and the meta data as to its source and reliability into account to see if the Heuristic Gifting Engine deems this threat passes the threshold of a threat.
5) If the Heuristic Gifting Engine does deem there is a threat, the Heuristic Gifting Engine will then take into account all the other information it has learned regarding the Sender and the Recipient and based on that it will decide to remove this gift from the array of gifts and replace it with similar/alternative gift based on everything the Heuristic Gifting Machine has learned in that environment about Sender/Recipient/Gifts.
6) The Heuristic Gifting Engine will then inform the Sender of this change and offer them the chance of re-selection of the gift with suggestions based on what the Engine has learned.
7) The Heuristic Gifting Engine will also inform the Sender on new information that it has learned over time has passed, including but not limited to information about Recipient attributes.
   a. In the case of multiple gifts in the basket, the Heuristic Gifting Engine will inform the Recipient of priorities of the gifts that would best represent the intentions of the sender along with societal trends.
8) The Recipient receives the new gift or receives a new, safe prioritized array of gifts to make a selection from.

After compiling and processing all of this information, the engine is able continually to feedback this data into the gift selection process for both the user and sender to ensure a truly tailored gifting experience.

Equation 8—Appropriate Gifts

$$Appropriate Gifts ( at K ) = f ( Heuristic Gifting {Engine}_{ k} ) [ [ {S}_{n} ( {D}_{n , t , c} ) ] ⋃ [ {R}_{a} ( {D}_{a , t + Δ} ] ⋃ Gd ⋃ {\sum }_{Z = 1}^{n} ( {Ed}_{Z} ⋂ {W}_{Z} ⋂ {Rw}_{Z} ⋂ {Sw}_{Z} ) ]$$

*NOTE: DETLA T—TAKES TIME INTO CONCIDERATION

Where:
n=Sender ID
a=Recipient ID
S=Sender
R=Recipient
Rw=Importance to the Recipient
Sw=Importance to the Sender
D=Data (e.g. including buying data, selection data, attributes, characteristics and etc . . . )
t=time
K=Continuous Time
Gd=Gift Data
Wz=Weighting for External Data
Ed=External Data

An instance of this equation would be:
1) Machine gathers all data regarding relevant external information and data from the sender and recipient: including but not limited to: messages, gifting, recipients, dates, and etc.
2) Machine adds all the data collected and analyzed to a heuristic user database. This database is filled with all previous/past sender and recipient data.
3) Machine takes this data to create a set of recommended gifts that can be available for recipient.
4) Machine constantly updates these databases as time progresses and more data is collected.

Definitions
1. As used herein, the term “Characteristics” shall refer to descriptor data from the different gifts available to the sender or recipient
2. As used herein, the term “Attributes” shall refer to descriptor data of choices and traits the sender or recipient possesses
3. As used herein, the term “eGifting Architecture” shall refer to the process of analyzing gifts, presenting a curated interface for gift senders, allowing the sender to select a gift or array of gifts, sending gifts in the present or into the future, correcting and customizing a set of gifts for the recipient, allowing the recipient to choose from the set of gifts, and storing this data for further analysis
4. As used herein, the term “Corrective Gifting Machine” shall refer to the machines which take time and importance of gifts into account to generate a corrected set of gifts for the recipient
5. As used herein, the term “Baskets” shall refer to the categorization in which each gift is placed by the corrective gifting machine
6. As used herein, the term “Heuristic Gifting Engine” shall refer to the engine which collects and analyzes all data points from the eGifting Architecture and relevant external information for future use and for finding the “perfect gift” for the recipient
7. As used herein, the term “External Data” shall refer to the data collected and analyzed by the heuristic engine.
8. As used herein, the term “Meta-Data” shall refer to the data about data collected and analyzed by the heuristic engine.
9. As used herein, the term “Weighting” shall refer to the level of importance attached to each data and meta data point within the heuristic engine

What is claimed is:

1. A method for a user to specify a set of gifts to be sent at a future time to a recipient, the method comprising:
providing the user with an array of currently available gifts;
receiving a selection for one of the array of currently available gifts based on selected characteristics of the array of gifts, sender attributes, or recipient attributes; and
sending, at a future time based on a selection from the user, the selected gift to a recipient.
